(19) United States
(12) Patent Application Publication
(10) Pub. No.: US 2009/0012684 A1
(43) Pub. Date: Jan. 8, 2009

(54) Apparatus for Avoiding a Collision

(76) Inventor: Joachim Thiele, Beilstein (DE)

Correspondence Address: KENYON & KENYON LLP, ONE BROADWAY, NEW YORK, NY, 10004, US

(21) Appl. No.: 11/666,835

(22) PCT Filed: Aug. 10, 2005
(86) PCT No.: PCT/EP05/53945

§ 371 Date: Apr. 3, 2008

(30) Foreign Application Priority Data
Oct. 29, 2004 (DE) 10 2004 052 519.6

(51) Int. Cl. B60T 7/22; G08G 1/00

(52) U.S. Cl. 701/70; 340/904

(57) ABSTRACT

An apparatus for avoiding a collision, or for reducing the consequences of a collision, of a motor vehicle with an object, the position and speed of an object with reference to the own vehicle being determined using an object detection sensor suite, and a determination being made as a function of those variables as to whether a collision is imminent, and an emergency braking action being triggered upon detection of an imminent collision, the driver activity being evaluated and the point in time of the automatic triggering of the emergency braking action being modifiable as a function of the driver activity.

### FIELD OF THE INVENTION

The present invention relates to an apparatus for avoiding a collision, or for reducing the consequences of a collision, of a motor vehicle with an object, the position and speed of an object with reference to the own vehicle being determined using an object detection sensor suite, and a determination being made as a function of those variables as to whether a collision is imminent, and an emergency braking action being triggered upon detection of an imminent collision, the driver activity being evaluated and the point in time of the automatic triggering of the emergency braking action being modifiable as a function of the driver activity.

### BACKGROUND OF THE INVENTION

German Patent Publication No. DE 103 49 211 discloses a braking assistant for motor vehicles, having a control device for controlling braking forces, a braking force sensor, and an evaluation device for detecting a driver's emergency braking input and for preparing for initiation of an emergency braking action, in which context the evaluation device receives and evaluates signals of a surrounding-area sensor suite.

### SUMMARY OF THE INVENTION

The essence of the present invention is to describe a system that can detect, using an object detection sensor suite, whether a collision with an object is imminent, and in that case can trigger and carry out an automatically triggered emergency braking action, the point in time of the triggering of the emergency braking action being modifiable as a function of the driver type that is recognized. Triggering of the emergency braking function is thereby adjusted to the driving ability of the current motor vehicle driver, so that a sporty driver, who is also usually capable of avoiding a collision by active driving interventions at a later point in time than a more leisurely driver, who often also requires a longer reaction time. According to the present invention, this is achieved by the features of the independent claim. Advantageous refinements and embodiments are evident from the dependent claims.

Advantageously, a driver type is assigned to the current driver by an evaluation of the driver activity, and the modification of the point in time of the automatic triggering of the emergency braking action is performed as a function of the driver type. Upon detection of an active or highly dynamic driver type, the point in time of the triggering of the emergency braking action is delayed, and upon detection of a more leisurely driver type, the point in time of the triggering of the emergency braking action is advanced.

It is additionally advantageous that the driver activity is evaluatable using at least one driver-operable actuation element.

It is particularly advantageous that the at least one driver-operable actuation element is an accelerator pedal; a brake pedal; a kickdown detection means for an automatic transmission, which means can be embodied, for example, as an accelerator pedal angle sensor that detects when the accelerator pedal has been almost completely depressed; a gear ratio selection means; a steering angle sensor; a signal horn switch; a high-beam flasher; or a combination thereof.

The driver activity is advantageously evaluatable using at least one vehicle-dynamics sensor.

It is particularly advantageous if the at least one vehicle-dynamics sensor is a longitudinal acceleration sensor, a transverse acceleration sensor, a locking prevention device, a vehicle-dynamics control system, a slip control system, or a combination thereof.

The values that represent the driver activity are advantageously reset each time the driver's door is opened and closed, or each time the engine is restarted.

Values are advantageously stored for multiple drivers, those values representing the driver activity and being assignable to the current driver using a seat adjustment memory function or using a fingerprint recognition system.

It is additionally advantageous that prior to an automatic triggering of the emergency braking action, an optical and/or acoustic and/or haptic and/or kinesthetic warning is outputted.

Implementation of the method according to the present invention in the form of a control element that is provided for a control unit of an adaptive spacing or speed control system of a motor vehicle is of particular importance. A program that is executable on a computation device, in particular on a microprocessor or signal processor, and is suitable for carrying out the method according to the present invention, is stored on the control element. In this case, therefore, the invention is implemented by way of a program stored on the control element, so that this control element equipped with the program represents the invention in the same way as the method for whose execution the program is suitable. An electrical storage medium, for example a read-only memory, can be used, in particular, as the control element.

Further features, potential applications, and advantages of the invention are evident from the description below of exemplary embodiments of the invention that are depicted in the Figures of the drawings. All features described or depicted, of themselves or in any combination, constitute the subject matter of the invention, irrespective of their grouping in the claims or their internal references, and irrespective of their presentation and depiction in the description and the drawings, respectively.

### BRIEF DESCRIPTION OF THE DRAWINGS

Exemplary embodiments of the invention are explained below with reference to drawings, in which:

FIG. 1 is a schematic block diagram of an embodiment of the apparatus according to the present invention; and

FIG. 2 is a flow chart of an embodiment of the method according to the present invention.

### DETAILED DESCRIPTION

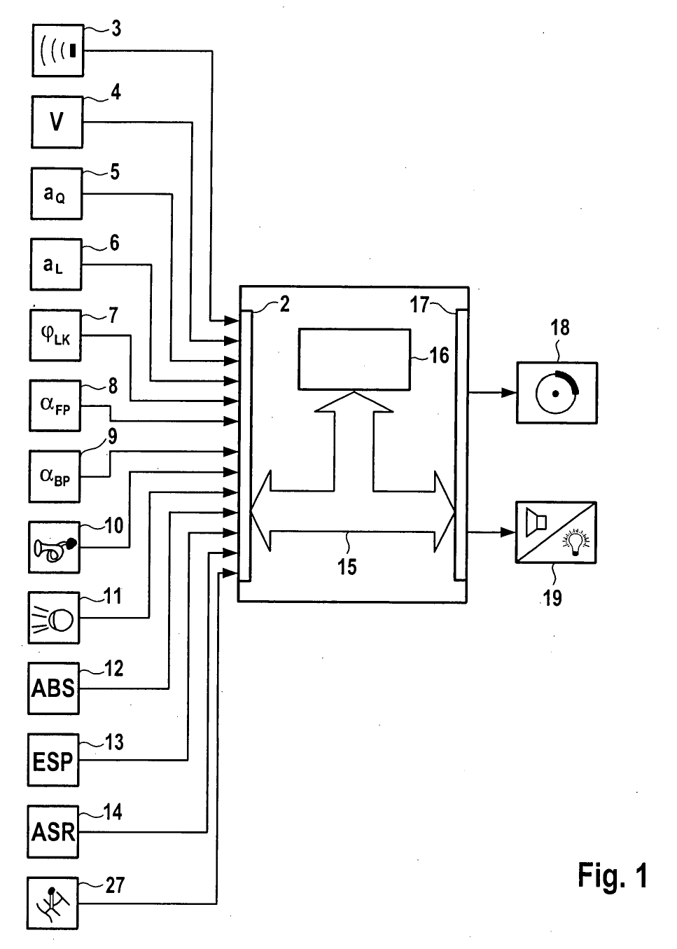

FIG. 1 depicts an emergency braking control unit 1 that has an input circuit 2 with the aid of which input signals are deliverable to emergency braking control unit 1. Provided as input signals are, for example, signals of driver-operable actuation elements as well as signals from vehicle-dynamics sensors and vehicle-dynamics systems. For example, an object detection sensor suite 3 is provided which monitors the region in front of the vehicle for the presence of objects, and can determine the position and speed of the object with reference to the own vehicle. This object detection sensor suite can be embodied, for example, as a radar sensor or laser sensor that emits electromagnetic waves and receives and evaluates the signals reflected from objects. Additionally delivered to input circuit 2 is a signal of a speed sensor 4, which signal represents the vehicle speed. It is possible with the aid of this speed signal to convert the relative values, determined by object detection sensor suite 3, into absolute values for the object. In addition, the signal a_{Q} of a transverse acceleration sensor 5 is made available as an input signal and delivered to input circuit 2. The signal a_{L} of a longitudinal acceleration sensor 6 is likewise determined and is also delivered to input circuit 2. By using these two acceleration sensors 5, 6 it is possible to determine the longitudinal and transverse accelerations being experienced by the vehicle as a consequence of driver stipulations. Additionally delivered to input circuit 2 is the signal φ_{LK} of a steering angle sensor 7, with the aid of which signal it is possible to detect the angle through which the steering wheel of the vehicle has been turned. On the one hand the extent to which the vehicle's steering system is being deflected can be ascertained with the aid of this signal; on the other hand, by differentiation of this signal over time, it is possible to determine the value φ·_{LK} that represents the steering angle rate and indicates how quickly the driver is actuating the steering wheel. Also delivered to input circuit 2 is the signal α_{FP} that derives from an angle sensor of accelerator pedal 8. A signal α_{BP} of a brake pedal sensor 9 is likewise determined, and is likewise delivered to input circuit 2. With the aid of the signals α_{FP} and α_{BP} it is possible to ascertain how strongly the driver is stepping on the accelerator pedal or brake pedal and, by differentiation of these signals over time, how quickly he or she is performing those actions. It is also possible to determine how often and how quickly the driver is alternating between an acceleration (a>0) and a deceleration (a<0) of the vehicle, which is particularly informative for determining the driver type. Additionally delivered to input circuit 2 is the signal of a signal horn switch 10, which signals to emergency braking control unit 1 how often the driver is actuating the vehicle horn. Additionally delivered to input circuit 2 is the signal of a high-beam flasher 11. Most vehicles possess, for switching over between low beams and high beams, a lever that can be displaced into a latching position (high-beam switch) and a non-latching position (high-beam flasher). The non-latching position, referred to here as the high-beam flasher, is often used to emit brief high-beam signals that are also referred to as a “light horn.” With the aid of this high-beam flasher 11, it is possible to determine how often the driver is actuating the vehicle's light horn, this once again being used to determine the driver type. Additionally provided is a locking prevention device 12 which emits a signal when one of the vehicle's wheels locks and is prevented by that device from locking for a longer period. Additionally provided is a vehicle-dynamics control device 13 that senses critical vehicle-dynamics situations and, if applicable, brakes or accelerates individual wheels in controlled fashion in order to keep the vehicle on a stable track. In the event of a vehicle-dynamics intervention, this vehicle-dynamics control system 13 likewise emits a signal that is delivered to input circuit 2. A slip control device 14 can also be provided, which upon acceleration of the vehicle prevents an individual wheel, or multiple wheels, from slipping, and brakes the slipping wheels in such a way that slippage of those wheels is prevented. An output signal is once again generated in the event of an intervention by this slip control device 14. The output signals that are outputted by locking protection device 12 or vehicle-dynamics control device 13 or slip control device 14 are likewise delivered to input circuit 2, and signal to emergency braking control unit 1 when and how often the vehicle is being operated at its physical limits. Active drivers, who perform vigorous accelerations, sharp decelerations, and large transverse accelerations with their vehicle, reach the vehicle's physical limits more often than drivers who operate the vehicle in more leisurely fashion, and thus more slowly and in more-stable driving states. Additionally provided is a device 27 which determines how often the driver actuates a gear ratio selection means 27. In the case of manual transmissions, the frequency of gear changing is therefore detectable, and in the case of automatic transmissions it is possible to detect how often the driver manually intervenes in terms of gear ratio selection, thereby likewise allowing an inference as to the driver's driving style. This signal that indicates when the driver intervenes manually in terms of gear ratio selection is likewise delivered to input circuit 2. The input signals delivered to input circuit 2 are delivered, in emergency braking unit 1, to a data exchange device 15 that conveys those input signals to a calculation means 16. In this calculation means 16, the input signals are evaluated and stored, for example using static frequency distributions, as to how often the driver operates at the physical limits of the vehicle, how often and how vigorously he or she accelerates, how often and how vigorously he or she brakes the vehicle, how often he or she alternates between acceleration and deceleration, how often he or she actuates the kickdown in an automatic transmission and how often he or she draws attention to him- or herself in traffic using a light horn or signal horn, and how vigorously he or she imparts transverse acceleration to the vehicle by steering interventions. For some of these variables it is furthermore possible, by differentiation of these variables over time, to determine not only the frequency of these driver activities but also the intensity of these driver interventions, for example by analyzing not only the frequency of a steering motion but also the steering angle rate or the gas pedal actuation rate or the brake pedal actuation rate. An additional determination is made in calculation means 16, from the position and speed of the detected object, as to whether a collision of the own vehicle with the detected object is imminent, and whether the driver still physically has the possibility of avoiding a collision by way of a steering or braking or acceleration intervention. If it is detected that a collision is unavoidable or that an unavoidable collision situation is imminent, an emergency braking triggering signal is conveyed from calculation means 16 via data exchange device 15 to output circuit 17. Output circuit 17 conveys this emergency braking triggering signal to deceleration devices 18 which, with a deceleration of maximum possible intensity, protect the vehicle from the imminent collision or at least diminish the intensity of the collision. From the input variables of devices 5 to 14 and 27, calculation device 16 furthermore determines the driver type to which the current vehicle driver belongs, and can accordingly vary the point in time at which emergency braking is triggered in such a way that for a sporty driver, who moves his or her vehicle in highly dynamic fashion, the emergency braking action is triggered later, since this driver is often more capable of preventing a collision than in the case of a leisurely and less dynamic driver type. Provision can furthermore be made for input variables to be deliverable to emergency braking control device 1 that, for example, indicate or signal the opening and closing of the driver's door when the engine is restarted. Because this driver type identification is different for each vehicle driver, and because knowledge of a change in driver is necessary when determining the point in time at which the automatically triggered emergency braking action is triggered, provision can furthermore be made for the previously stored values regarding driver type to be reset to initial values when the driver's door is opened or closed or when the vehicle's engine is restarted. In vehicles that have an electric seat adjusting device in which seat positions for different drivers are storable, it is furthermore possible for previously stored driver-type values to be retrieved on the basis of the currently selected stored seat position, and additionally used for driver type classification. It may likewise be possible, in the case of vehicles having coded car keys, to detect, on the basis of the vehicle key presently being used, which driver is driving the vehicle. In addition, vehicles are now available that possess fingerprint reading devices with the aid of which driver-specific settings are storable and retrievable later. Using a fingerprint reading device of this kind, it is additionally possible to retrieve the driver-type values of a driver who has already previously been classified and can be recognized using his or her fingerprint. According to a further embodiment, it is also possible for calculation means 16 to output, shortly before triggering of the automatically triggered emergency braking action, a warning signal that is delivered with the aid of data exchange device 15 to output circuit 17, which conveys that signal to a warning device 19. This warning device 19 can warn the driver, for example acoustically, optically, and/or kinesthetically, that an automatic triggering of an emergency braking action is imminent.

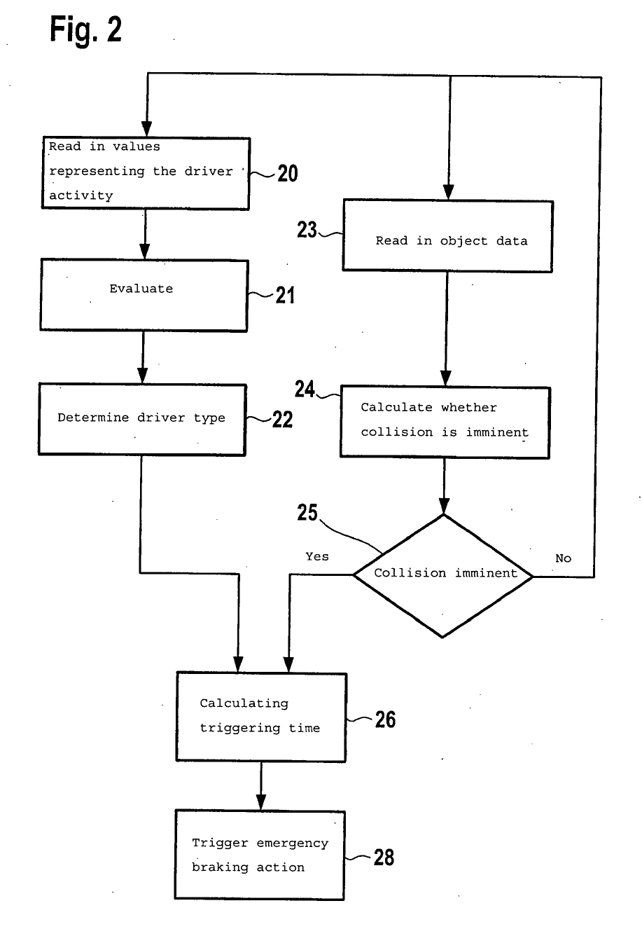

FIG. 2 depicts a further embodiment of the method according to the present invention. According to this method, in step 20 the values that represent the driver activity are read in. These values typically derive from devices 5 to 14 and 27, and in step 21 are evaluated statistically with reference to their frequency or magnitude, whereupon in step 22 a driver type can be identified using the static evaluation results. This driver type determines whether the driver is a sporty one who moves the vehicle in highly dynamic fashion and often reaches the vehicle's physical limits, or whether he or she is instead a circumspect and more leisurely driver who, for example because of a longer reaction time, operates the vehicle in less dynamic fashion and only seldom, or never, at its physical limits. In step 23, object data are read in that describe the position as well as the speed and, if applicable, the direction of the detected object, as well as data that, for example, describe the speed of the own vehicle. From these object data and from data that describe the own-vehicle motion, step 24 calculates whether a collision is imminent. If it was determined in step 24 that a collision is imminent, in step 25 execution branches to Yes. If it was found in step 24 that a collision was not imminent, then in step 25 execution branches to No, and the next calculation cycle continues by reading in the values that represent the driver activity and by reading in the object data and the data that describe the own-vehicle motion. If execution branched to Yes in step 25 because an imminent collision was detected, the point in time at which the automatic emergency braking function is triggered is calculated in step 26 in consideration of the driver type determined in step 22. Then in step 28, at the point in time calculated in step 26, the emergency braking action is triggered and the collision is avoided if possible, but at least the impact severity and therefore the consequences of the collision are diminished.

1-10. (canceled)

11. An apparatus for avoiding a collision, or for reducing the consequences of a collision, of a motor vehicle with an object, comprising:
an object detection sensor suite for determining a position and speed of an object with reference to the vehicle; and
an arrangement for making a determination as a function of those variables as to whether a collision is imminent, and an emergency braking action being triggered upon detection of an imminent collision, wherein the driver activity is evaluated, and the point in time of the automatic triggering of the emergency braking action is modifiable as a function of the driver activity.

12. The apparatus as recited in claim 11, wherein a driver type is assigned to the current driver by an evaluation of the driver activity, and the modification of the point in time of the automatic triggering of the emergency braking action is performed as a function of the driver type.

13. The apparatus as recited in claim 11, wherein the driver activity is evaluatable using at least one driver-operable actuation element.

14. The apparatus as recited in claim 13, wherein the at least one driver-operable actuation element is one of:
an accelerator pedal;
a kickdown detection means for an automatic transmission;
a brake pedal;
a gear ratio selection means;
a steering angle sensor;
a signal horn nonlocking switch;
a high-beam nonlocking switch; and
a combination thereof.

15. The apparatus as recited in claim 11, wherein the driver activity is evaluatable using at least one vehicle-dynamics sensor.

16. The apparatus as recited in claim 15, wherein the at least one vehicle-dynamics sensor is one of a longitudinal acceleration sensor;
a transverse acceleration sensor;
a locking prevention device;
a vehicle-dynamics control system;
a slip control system; and
a combination thereof.

17. The apparatus as recited in claim 11, wherein the values that represent the driver activity are reset each time the driver's door is opened and closed, or each time the engine is restarted.

18. The apparatus as recited in claim 11, wherein values are storable for multiple drivers, those values representing the driver activity and being assignable to the current driver using a seat adjustment memory function or using a fingerprint recognition system.

19. The apparatus as recited in claim 11, wherein prior to an automatic triggering of the emergency braking action, an optical and/or acoustic warning is outputted.

20. A method for avoiding a collision, or for reducing the consequences of a collision, of a motor vehicle with an object, comprising:
determining a position and speed of an object with reference to the vehicle using an object detection sensor suite;
making a determination as a function of those variables as to whether a collision is imminent; and
triggering an emergency braking action upon detection of an imminent collision, wherein the driver activity is evaluated, and the point in time of the automatic triggering of the emergency braking action is modifiable as a function of the driver activity.
